(19) United States
(12) Patent Application Publication
(10) Pub. No.: US 2006/0077267 A1
(43) Pub. Date: Apr. 13, 2006

(54) Image capturing apparatus, image sensor driving circuit, and image capturing method

(75) Inventor: Toshihito Kido, Matsubara-shi (JP)

Correspondence Address: SIDLEY AUSTIN LLP, 717 NORTH HARWOOD, SUITE 3400, DALLAS, TX, 75201, US

(73) Assignee: KONICA MINOLTA PHOTO IMAGING, INC.

(21) Appl. No.: 11/112,547

(22) Filed: Apr. 22, 2005

(30) Foreign Application Priority Data
Oct. 7, 2004 (JP) JP2004-294492

(51) Int. Cl. H04N 5/335

(52) U.S. Cl. 348/241

(57) ABSTRACT

In an image capturing apparatus, a gain of an amplifier for amplifying an image signal output from an image sensor is variable, and a waveform pattern of drive pulses applied to the image sensor is changed in accordance with the gain. For example, when the gain is lower than 12 dB, the drive pulses are set to have an A pattern, to make the number of chare storage gates equal to four. When the gain is equal to or higher than 12 dB, the drive pulses are set to have a B pattern, to make the number of charge storage gates equal to three. In the image sensor, while an amount of dark noise decreases as the number of charge storage gates is smaller, the number of charge storage gates is reduced in the foregoing manner when the gain is set to a high value, to prevent degradation of a signal-to-noise ratio. Hence, degradation in quality of a captured image can be prevented even in photographing a subject with a low brightness.

This application is based on application No. 2004-294492 filed in Japan, the contents of which are hereby incorporated by reference.

### BACKGROUND OF THE INVENTION

1. Field of the Invention

The present invention relates to an image capturing technique utilizing an image sensor which generates an image signal of a subject.

2. Description of the Background Art

In a digital camera (image capturing apparatus) employing a CCD as an image sensor, predetermined drive pulses are fed to the image sensor from a timing generator in a monitoring mode or in capturing a still image, to set the number of electrons which can be transferred from a photoelectric converter (photoelectric conversion cell).

In the meantime, in photographing a subject having a low brightness, a gain is increased in an amplifier for amplifying an image signal output from an image sensor, to thereby overcome shortages of exposure.

However, to increase a gain of an amplifier as described above would involve amplification of a dark noise contained in an output signal of an image sensor. Accordingly, a signal-to-noise ratio is reduced, to cause a problem of degradation in quality of a captured image. Particularly in an image sensor, there is a tendency for an amount of dark noise to increase as the number of transferable electrons increases. Thus, a captured image would be influenced by amplification of dark noise.

### SUMMARY OF THE INVENTION

The present invention is directed to an image capturing apparatus.

According to the present invention, the image capturing apparatus includes: an image sensor for generating an image signal; a detector for detecting a brightness of a subject; and a driver for selectively outputting one of a first drive signal and a second drive signal to the image sensor, in accordance with the brightness of the subject detected by the detector. In the image capturing apparatus, the image sensor is set to have a first charge transfer capacity when the first drive signal is input to the image sensor from the driver, and the image sensor is set to have a second charge transfer capacity which is smaller than the first charge transfer capacity when the second drive signal is input to the image sensor from the driver. Accordingly, it is possible to prevent degradation in quality of a captured image even in photographing a subject with a low brightness.

According to a preferred embodiment of the present invention, in the image capturing apparatus, the number of charge storage gates in the image sensor is changed depending on a drive signal supplied from the driver, by which the first transfer capacity and the second charge transfer capacity are switched. Accordingly, it is possible to appropriately change a charge transfer capacity, to improve image quality.

Also, the present invention is directed to an image sensor driving circuit and an image capturing apparatus.

It is therefore an object of the present invention to provide an image capturing technique which allows for prevention of degradation of a quality of a captured image even in photographing a subject having a low brightness.

These and other objects, features, aspects and advantages of the present invention will become more apparent from the following detailed description of the present invention when taken in conjunction with the accompanying drawings.

### BRIEF DESCRIPTION OF THE DRAWINGS

FIGS. 1 and 2 illustrate an appearance of an image capturing apparatus according to a first preferred embodiment of the present invention;

FIG. 3 is a functional block diagram of the image capturing apparatus;

FIG. 4 shows a relationship between an input voltage applied to an image sensor and the saturation electron number in the image sensor;

FIG. 5 is a view for explaining a saturation level of the image sensor;

FIG. 6 shows a relationship between the number of charge storage gates and the transferable electron number;

FIG. 7 is a conceptual diagram for showing a relationship between a dark noise and the number of charge storage gates;

FIGS. 8A and 8B show waveform patterns of drive pulses output from a timing generator;

FIGS. 9A and 9B are enlarged views of the waveform patterns of the drive pulses shown in FIGS. 8A and 8B;

FIG. 10 is a flow chart showing basic operations of the image capturing apparatus; and

FIG. 11 is a flow chart showing basic operations of an image capturing apparatus according to a second preferred embodiment of the present invention.

### DESCRIPTION OF THE PREFERRED EMBODIMENTS

### First Preferred Embodiment

Structure of Image Capturing Apparatus

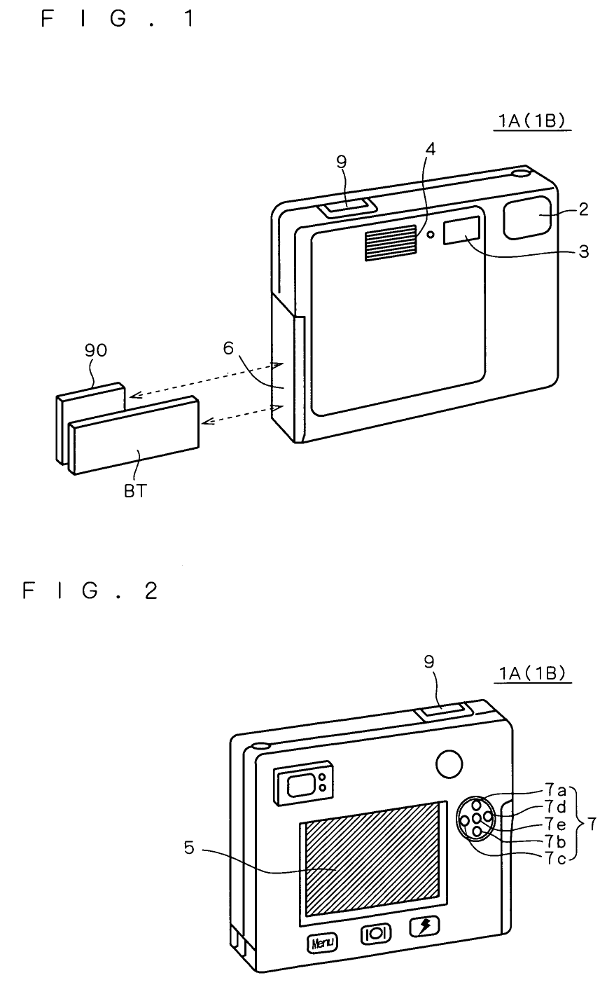

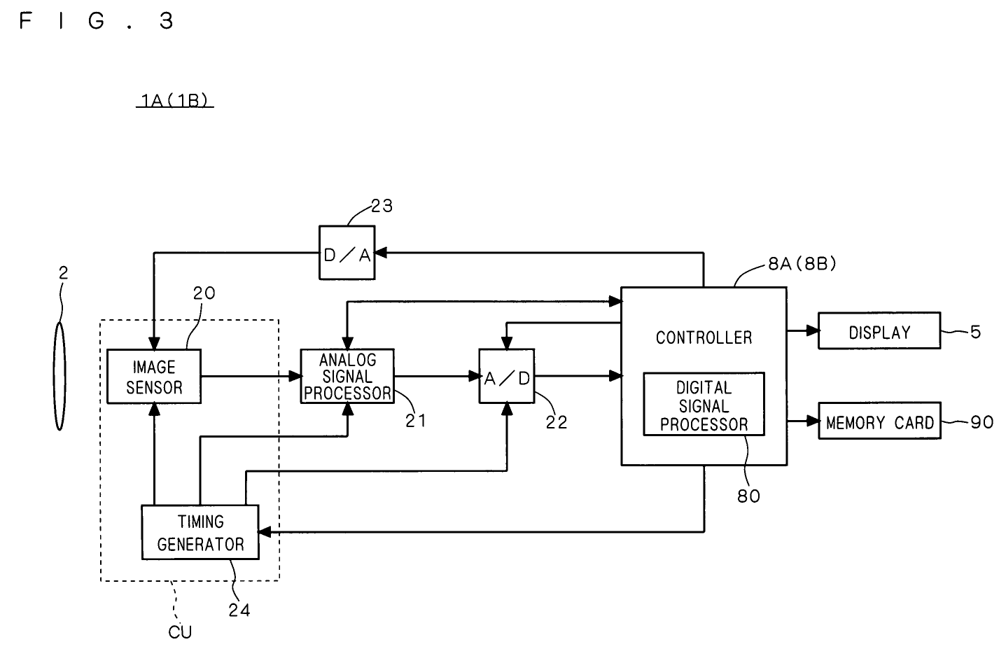

FIGS. 1 and 2 illustrate an appearance of an image capturing apparatus 1A according to a first preferred embodiment of the present invention. FIG. 1 is a schematic perspective view of the image capturing apparatus 1A when viewed from the front, and FIG. 2 is a schematic perspective view of the image capturing apparatus 1A when viewed from the back.

The image capturing apparatus 1A is configured to function as a digital camera, for example. The image capturing apparatus 1A includes a taking lens 2, an optical finder 3, and an electronic flash 4 on a front face thereof, and also includes a shutter release button 9 on a top face thereof.

The image capturing apparatus 1A further includes a liquid crystal display (which will be hereinafter simply referred to as a “display”) 5 and a group of buttons 7 on a back face thereof. The group of buttons 7 includes cursor buttons 7a, 7b, 7c, 7d, and 7e arranged in a cross.

The shutter release button 9 is a two-position push-button switch which can be placed in two distinguishable and detectable states of: a state where the shutter release button 9 is pressed halfway down by a photographer (which will be hereinafter also referred to as a “state S1”); and a state where the shutter release button 9 is fully pressed down by a photographer (which will be hereinafter also referred to as a “state S2”). In the state (S1) where the shutter release button 9 is pressed halfway down, automatic focus control is started. In the state (S2) where the shutter release button 9 is fully pressed down, capture of a still image (a principal operation in photographing) which is to be recorded is started.

The display 5 is used for display of a preview image (which can be also referred to as a “live view image”) in the monitoring mode, playback of a recorded image, and the like.

For display of a live view image, after the image capturing apparatus 1A is powered or a still image is once captured, an image of subject is repeatedly captured every 1/30 second with a low resolution, and the captured images are displayed in an animated manner on the display 5. In this manner, a photographer acknowledges a position, a size, and the like of the subject in the captured images, so that he can carry out framing.

A lid 6 is provided to cover a battery compartment and a memory card pocket. In other words, the battery compartment accommodating a battery BT for supplying a power and the memory card pocket into which a memory card 90 serving as a removable recording medium is inserted are provided inside the lid 6. Image data or the like provided as a result of capture of a still image is recorded in the memory card 90 inserted into the memory card pocket.

FIG. 3 is a functional block diagram of the image capturing apparatus 1A.

An image sensor 20 is configured to function as a CCD, for example. The image sensor 20 captures an image of a subject and generates an electronic image signal. More specifically, the image sensor 20 performs photoelectric conversion on an optical image of a subject formed by the taking lens 2, to convert the optical image into an image signal composed of red (R)-, green (G)-, and blue (B)-color components for each pixel (in other words, a signal composed of a sequence of plural pixel signals respectively obtained by pixels).

The image signal generated by the image sensor 20 is supplied to an analog signal processor 21, which then performs predetermined analog signal processing on the supplied image signal (analog signal). More specifically, the analog signal processor 21 includes an automatic gain control (AGC) circuit. The analog signal processor 21 is capable of controlling a level of the image signal by having the automatic gain control circuit therein controlling a gain. That is, in the automatic gain control circuit, a gain (an amplification factor) at which the image signal generated by the image sensor 20 is amplified can be changed, and is determined in accordance with a brightness of each subject.

An analog-to-digital signal processor (A/D) converter 22 functions to covert each of the pixel signals forming the image signal which has been amplified by the analog signal processor 21, into a 10-bit digital signal, for example. A digital signal provided as a result of analog-to-digital conversion in the A/D converter 22 is input to a digital signal processor 80 within a controller 8A, and then subjected to various image processing such as white balance (WB) control, γ correction, and color correction in the digital signal processor 80.

A digital-to-analog (D/A) converter 23 converts the digital signal transmitted from the controller 8A into an analog signal, and outputs the analog signal to the image sensor 20. By changing a potential applied to the image sensor 20 using the D/A converter 23, a change in a saturation level becomes possible in the image sensor 20 (details about which will be given later).

A timing generator 24 functions to generate various pulses for driving the image sensor 20, the analog signal processor 21, and the A/D converter 22. The timing generator 24 is capable of outputting various kinds of drive pulses. The various kinds of drive pulses are generated based on timing pulses supplied from the controller 8A.

The timing generator 24 and the image sensor 20 are formed integrally with each other in an image sensor driving circuit CU.

The image data which has been subjected to the image processing in the digital signal processor 80 is displayed on the display 5, or recorded in the memory card 90.

The controller 8A includes a CPU functioning as a computer and a memory, and comprehensively controls respective parts of the image capturing apparatus 1A.

Drive of Image Sensor 20

In the image sensor 20, a saturation level and the number of charge storage gates arranged in a vertical transfer path (vertical CCD) can be changed depending on a voltage applied by the D/A converter 23 and the drive pulses supplied from the timing generator 24. Details will be given as follows.

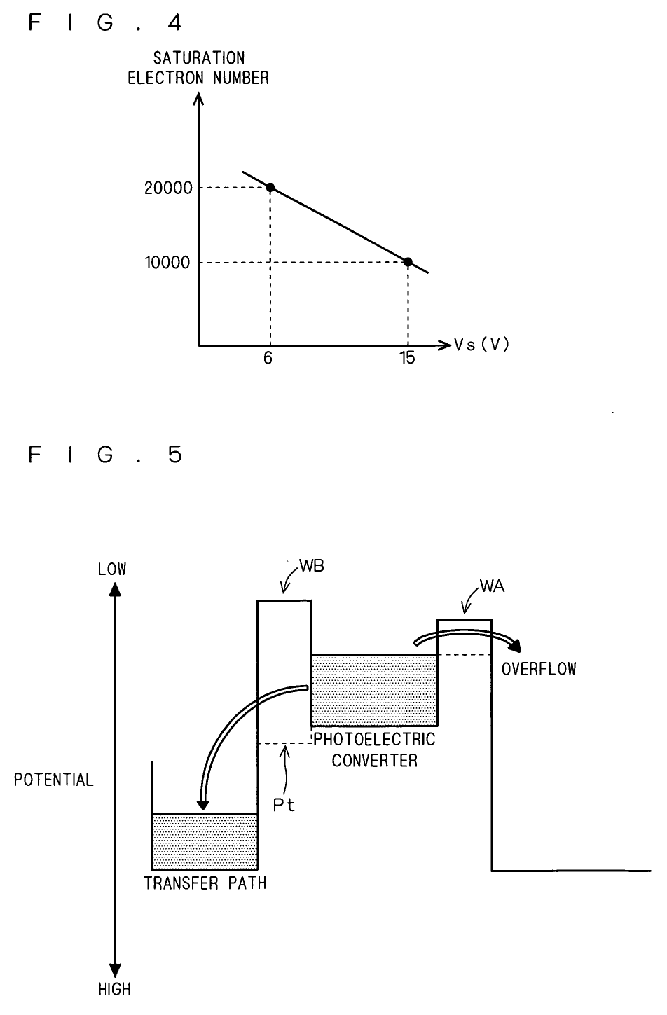

FIG. 4 shows a relationship between an input voltage Vs applied to the image sensor 20 and the saturation electron number. In FIG. 4, a horizontal axis represents the input voltage Vs applied by the D/A converter 23, and a vertical axis represents the maximum number of electrons which can be stored in a photoelectric conversion cell (photoelectric converter) without causing saturation of the image sensor 20.

For example, when the input voltage Vs applied by the D/A converter 23 is 6 V, the saturation electron number of the photoelectric converter of the image sensor 20 is set to 20000. On the other hand, when the input voltage Vs is 15 V, the saturation electron number of the photoelectric converter of the image sensor 20 is set to 10000. As such, the saturation level (corresponding to the saturation electron number) of the photoelectric converter of the image sensor 20 can be changed through a change in the input voltage Vs applied to the image sensor 20. It is additionally noted that when the saturation electron number is 20000, the image sensor 20 can provide an output voltage of approximately 500 mV, and when the saturation electron number is 10000, the image sensor 20 can provide an output voltage of approximately 250 mV.

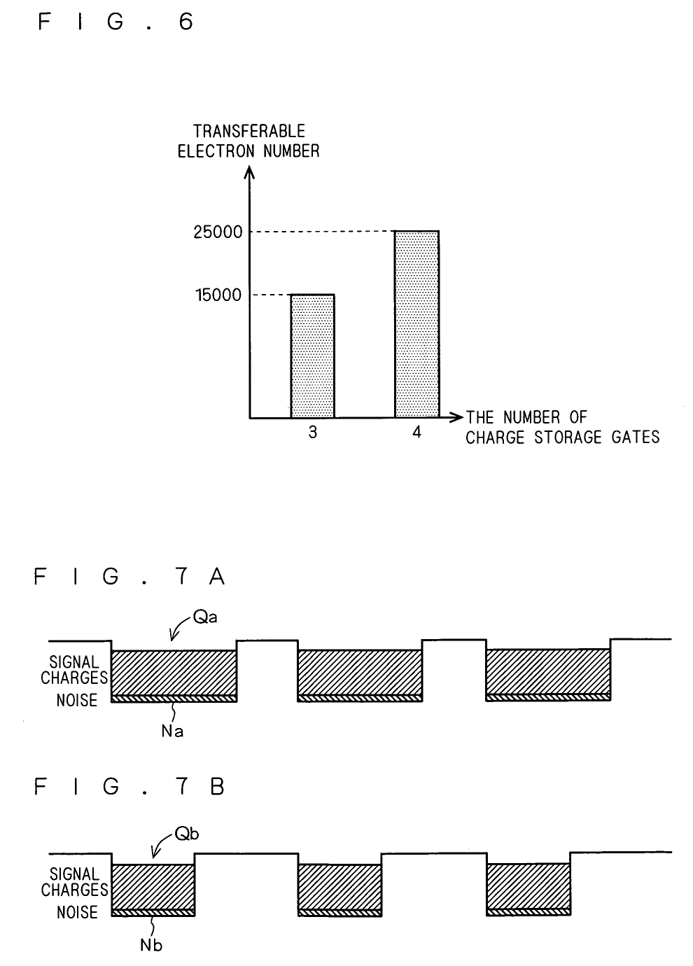

The input voltage Vs is changed in accordance with a change in a level (i.e., a potential) Ps of a potential barrier WA shown in FIG. 5. By changing the level Ps, the saturation level beyond which stored charges overflow can be changed. Also, to lower a level Pt of a potential barrier WB shown in FIG. 5 makes it possible to shift stored charges from the photoelectric converter to the vertical transfer path in the image sensor 20.

As described above, the saturation electron number can be changed through a change in the input voltage Vs applied to the image sensor 20. In the first preferred embodiment, the saturation level corresponding to the saturation electron number which is set to 20000 (when Vs is equal to 6 V) will be referred to as a “normal saturation level, and the saturation level corresponding to the saturation electron number which is set to 10000 (when Vs is equal to 15 V) will be referred to as a “low saturation level”.

FIG. 6 shows a relationship between the number of charge storage gates and the transferable electron number. In FIG. 6, a horizontal axis represents the number of charge storage gates of the image sensor 20, and a vertical axis represents the number of electrons which can be transferred from the photoelectric converter (the transferable electron number).

As shown in FIG. 6, when the number of charge storage gates is equal to three, the transferable electron number is set to 15000. On the other hand, when the number of charge storage gates is equal to four, the transferable electron number is set to 25000. As such, the transferable electron number is controlled by the number of charge storage gates. Now, a relationship between the number of charge storage gates and the saturation level (the saturation electron number) shown in FIG. 4 will be described.

In a case where the input voltage Vs applied to the image sensor 20 is 6 V, the saturation electron number of the photoelectric converter is set to 20000 (refer to FIG. 4). In this case, when the number of charge storage gates is three, the transferable electron number is set to 15000. As such, all charges stored in each pixel in which a level close to the saturation level are stored (i.e., each pixel on which an image of a subject having a high brightness is formed) cannot be transferred.

On the other hand, in a case where the input voltage Vs applied to the image sensor 20 is 15 V, the saturation electron number of the photoelectric converter is set to 100000 (refer to FIG. 4). In this case, all charges stored in each pixel can be transferred, whether the number of charge storage gates is three or four. Under such situation, the number of charge storage gates is set to three because to do so could more significantly suppress a dark current, to provide for improvement in image quality, in the image capturing apparatus 1A.

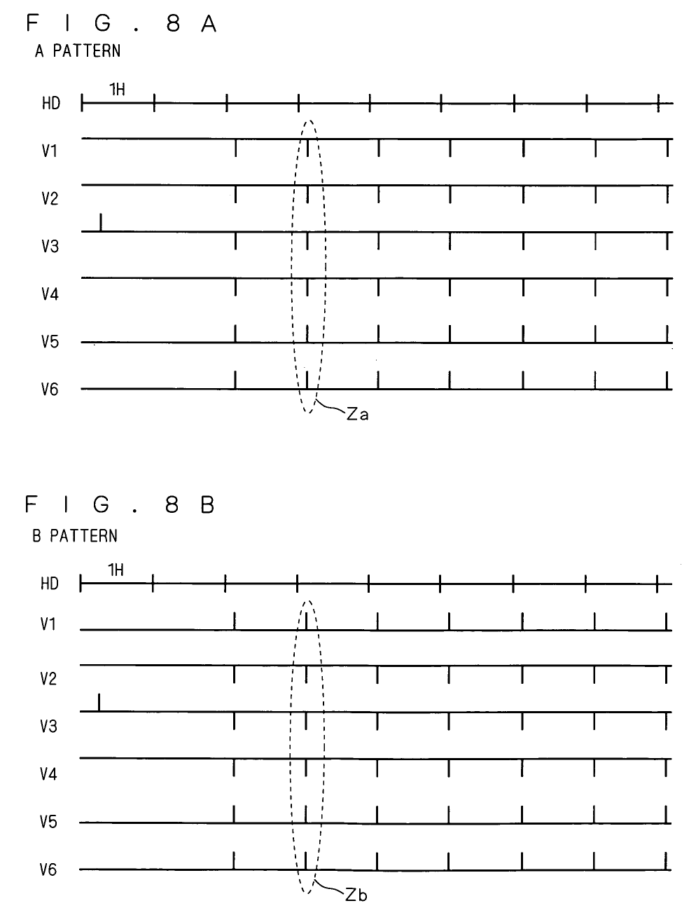

Next, suppression of a dark current will be described in detail with reference to FIGS. 7A and 7B.

FIGS. 7A and 7B are conceptual diagrams each for showing a relationship between a dark noise and the number of charge storage gates. FIG. 7A shows a relationship between a dark noise and the number of charge storage gates which is set to four, and FIG. 7B shows a relationship between a dark noise and the number of charge storage gates which is set to three. Additionally, FIGS. 7A and 7B illustrate a manner in which electric charges denoted by hatched regions are sequentially transferred.

A charge transfer capacity Qa (shown in FIG. 7A) corresponding to the transferable electron number in a case where the number of charge storage gates is four is larger than a charge transfer capacity Qb (shown in FIG. 7B) in a case where the number of charge storage gates is three. Also, an absolute amount of dark noise Na (shown in FIG. 7A) contained in transferred charges in the case where the number of charge storage gates is four is larger than an absolute amount of dark noise Nb (shown in FIG. 7B) in the case where the number of charge storage gates is three.

Therefore, in the case where the number of charge storage gates is four, when an amount of signal (the electron number) is great, a certain degree of high signal-to-noise ratio can be ensured although the amount of dark noise Na is relatively large. In contrast thereto, when an amount of signal is small, a proportion of the amount of the dark noise Na to the amount of signal is increased, so that a signal-to-noise ratio is reduced.

On the other hand, in the case where the number of charge storage gates is three, when an amount of signal is small, a certain degree of high signal-to-noise ratio can be ensured because the amount of the dark noise Nb is small. In contrast thereto, when an amount of signal is great, the charge transfer capacity Qb is easily exceeded because of its smallness. Thus, it is impossible to transfer all charges.

As described above, increase in the number of charge storage gates results in increase in the amount of dark noise. However, by determining the number of charge storage gates depending on the number of transferred electrons, it is possible to appropriately suppress influences of dark noise.

The number of charge storage gates is determined in accordance with a waveform of the drive pulses supplied from the timing generator 24. Processes for the determination of the number of charge storage gates will be described in detail, as below. It is noted that, in the following description, a pattern of the waveform of the drive pulses which causes the number of charge storage gates to be set to four will be referred to as an “A pattern”, and a pattern of the waveform of the drive pulses which causes the number of charge storage gates to be set to three will be referred to as a “B pattern”.

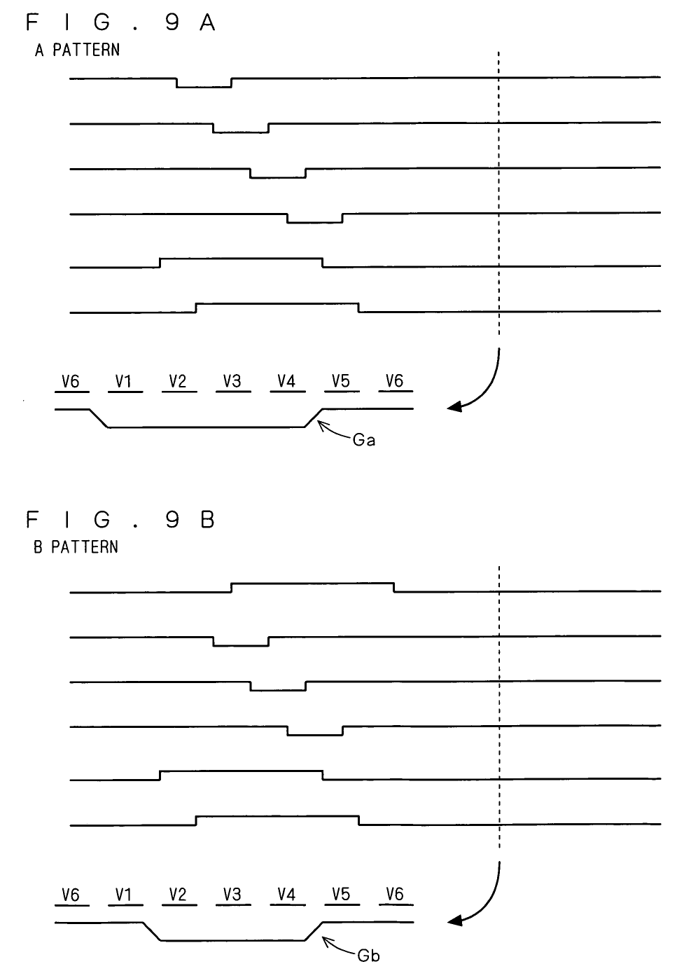

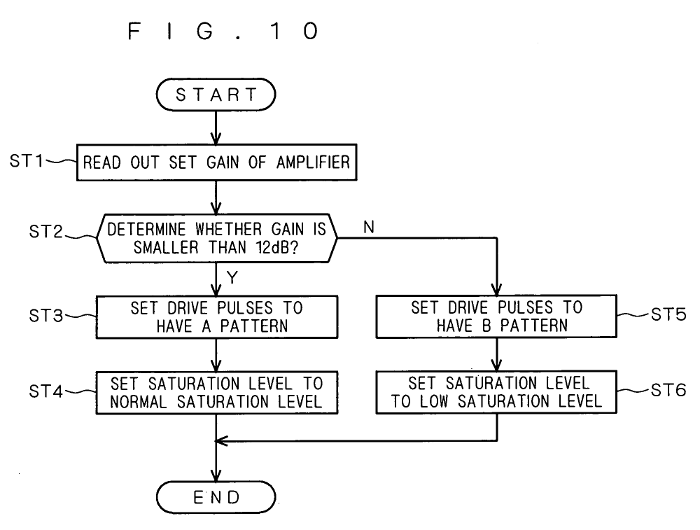

FIGS. 8A and 8B show waveform patterns of the drive pulses output from the timing generator 24. FIGS. 9A and 9B are enlarged views of the waveform patterns of the drive pulses shown in FIGS. 8A and 8B. More specifically, FIG. 9A is an enlarged view of a portion enclosed by a dashed line Za in the waveform pattern shown in FIG. 8A, and FIG. 9B is an enlarged view of a portion enclosed by a dashed line Zb in the waveform pattern shown in FIG. 8B.

In a case where the number of charge storage gates is four, the drive pulses are controlled so as to have the waveform pattern shown in FIG. 9A (A pattern) in the timing generator 24. In the A pattern, each signal which turns on the charge storage gate is superposed on respective drive pulses V1, V2, V3, and V4, to form a gate Ga including the four charge storage gates.

On the other hand, in the case where the number of charge storage gates is three, the drive pulses are controlled so as to have the waveform pattern shown in FIG. 9B (B pattern) in the timing generator 24. In the B pattern, each signal which turns on the charge storage gate is superposed on respective drive pulses V2, V3, and V4, to form a gate Gb including the three charge storage gates.

In the foregoing manner, when the drive pulses having the A pattern are applied to the image sensor 20 by the timing generator 24, the transferable electron number is set to 25000 corresponding to a first charge transfer capacity. On the other hand, when the drive pulses having the B pattern are applied to the image sensor 20 by the timing generator 24, the transferable electron number is set to 15000 corresponding to a second charge transfer capacity which is smaller than the first transfer capacity. Then, the first charge transfer capacity and the second charge transfer capacity are switched through a change in the number of charge storage gates of the image sensor 20.

As is made clear from the above description, it is possible to change the number of charge storage gates by changing the waveform pattern of the drive pulses fed to the image sensor 20. Accordingly, to determine the number of charge storage gates depending on the number of electrons (the amount of charges) generated in the photoelectric converter of the image sensor 20 would provide for improvement of a signal-to-noise ratio as described above in detail.

Setting of Gain in Analog Signal Processor 21

In the analog signal processor 21, a gain of an amplifier for amplifying an image signal can be controlled. The control of gain is exercised taking into account an input range of the A/D converter 22 of the succeeding stage. A specific description about the control of gain will be given as below.

First, the number of electrons stored in the photoelectric converter of the image sensor 20 and an output voltage of the image sensor 20 are proportional to each other. For example, it is assumed that when the number of electrons stored in the photoelectric converter of the image sensor is 20000, the image sensor 20 outputs a voltage of 500 mV, while when the number of electrons stored in the photoelectric converter of the image sensor is 10000, the image sensor 20 outputs a voltage of 250 mV. It is also assumed that an input range of the A/D converter 22 for converting an input analog signal to a 10-bit digital signal is from 0 to 1 V. Accordingly, when an input voltage in the A/D converter 22 is 0 V, a digital value “038 is output, while when an input voltage in the A/D converter is 1 V, a digital value “1023” is output.

In a case where the gain is set to +6 dB (so that a ratio of output to input is two) in the analog signal processor 21, if the output voltage of the image sensor 20 can be reduced to 500 mV, an output voltage of the analog signal processor 21 is equal to or lower than 1 V. As a result, a full dynamic range (input range) of the A/D converter 22 can be utilized.

On the other hand, in the case where the gain is set to +6 dB (so that a ratio of output to input is two) in the analog signal processor 21 in the same manner as described above, if the output voltage of the image sensor 20 is saturated at 250 mV (Vs=15 V in FIG. 4), the output voltage of the analog signal processor 21 is smaller than 500 mV. As a result, the full dynamic range of the A/D converter 22 cannot be utilized. An image on which image processing is performed without utilizing the full dynamic range of the A/D converter 22 is inferior in quality to an image generated by effectively utilizing the dynamic range of the A/D converter 22.

It should be noted, however, that even if the output voltage of the image sensor 20 is saturated at 250 mV, it is possible to make the output voltage of the analog signal processor 21 equal to or lower than 1 V by setting the gain to +12 dB (so that a ratio of output to input is four), for example, in the analog signal processor 21. Accordingly, the full dynamic range of the A/D converter 22 can be utilized. That is, in a case where the gain is set to a high value in the analog signal processor 21, no problem is caused even if the saturation level of the image sensor 20 is relatively low.

As is made clear from the above description, in a case where the number of electrons generated in the image sensor 20 is equal to or smaller than 10000 (so that an output voltage of the image sensor 20 is equal to or lower than 250 mV), for example, all stored charges can be transferred whether the number of charge storage gates is three or four as shown in FIG. 6. However, if the gain is set to +12 dB (so that a ratio of output to input is four) in the analog signal processor 21, setting the number of charge storage gates to three allow effective use of the dynamic range of the A/D converter 22, to thereby produce favorable effects on an image quality.

Operations of Image Capturing Apparatus 1A

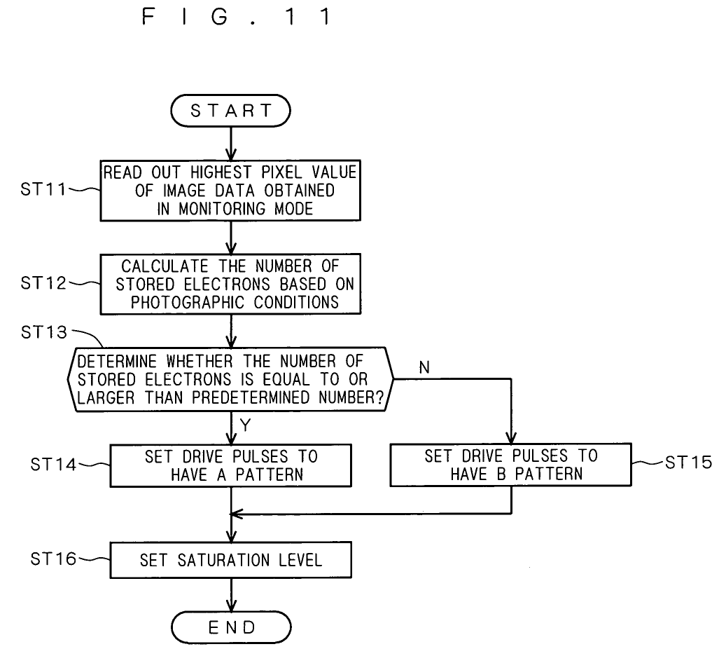

FIG. 10 is a flow chart showing basic operations of the image capturing apparatus 1A. The operations shown in the flow chart of FIG. 10 are implemented by the controller 8A, the timing generator 24, and the like.

In a step ST1, a gain of the amplifier which is set in the analog signal processor 21 is read out by the controller 8A. The gain (amplification factor) read out by the controller 8A is used for detection of a brightness of a subject.

In a step ST2, it is determined whether or not the gain read out in the step ST1 is lower than 12 dB. If it is determined that the gain is lower than 12 dB, a step ST3 is performed. Otherwise, if it is determined that the gain is equal to or higher than 12 dB, a step ST5 is performed. That is, either the A pattern (when the step ST3 is performed), or the B pattern (when the step ST5 is performed), is selected as the waveform pattern of the drive pulses in accordance with the brightness of the subject which has been detected in the step ST1, in the timing generator 24. Subsequently, either the drive pulses having the A pattern or the drive pulses having the B pattern are output to the image sensor 20.

In the step ST3, the drive pulses fed to the image sensor 20 from the timing generator 24 are set to have the A pattern shown in FIG. 9A. More specifically, when the gain is set to be lower than 12 dB in the analog signal processor 21, the drive pulses having the A pattern are output to the image sensor 20. As a result, the number of charge storage gates in the image sensor 20 is set to four, so that the transferable electron number is set to the relatively large number, 25000.

In a step ST4, the saturation level of the image sensor 20 is set to the normal saturation level. More specifically, a voltage of 6 V is applied to the image sensor 20 by the D/A converter 23, and the saturation electron number is set to 20000.

In the step ST5, the drive pulses fed to the image sensor 20 from the timing generator 24 are set to have the B pattern shown in FIG. 9B. More specifically, when the gain is set to be equal to or higher than 12 dB in the analog signal processor 21, the drive pulses having the B pattern are output to the image sensor 20. As a result, the number of charge storage gates in the image sensor 20 is set to three, so that the transferable electron number is set to the relatively small number, 15000.

In a step ST6, the saturation level of the image sensor 20 is set to the low saturation level. More specifically, a voltage of 15 V is applied to the image sensor 20 by the D/A converter 23, and the saturation electron number is set to 10000.

As a result of the above-described operations of the image capturing apparatus 1A, the number of charge storage gates, i.e., the transferable electron number, is changed in accordance with the gain set in the analog signal processor 21. Hence, a dark noise can be suppressed, to thereby prevent degradation in quality of a captured image, even in photographing a subject having a low brightness.

### Second Preferred Embodiment

A structure of an image capturing apparatus 1B according to a second preferred embodiment of the present invention is similar to that of the image capturing apparatus 1A according to the first preferred embodiment with the exception that the image capturing apparatus 1B includes a controller configured differently from the controller 8A of the image capturing apparatus 1A.

A controller 8B of the image capturing apparatus 1B functions to control the image capturing apparatus 1B so that the image capturing apparatus 1B operates as follows.

Operations of Image Capturing Apparatus 1B

FIG. 11 is a flow chart showing basic operations of the image capturing apparatus 1B. The operations shown in the flow chart of FIG. 11 are implemented by the controller 8B, the timing generator 24, and the like.

In a step ST11, the highest brightness value of image data obtained in the monitoring mode in which a live view image is displayed is read out by the controller 8B. Then, a brightness of a subject is detected based on the highest brightness value of the image data as read out. The brightness of the subject corresponds to the number of electrons which will be later described in detail.

In a step ST12, the number of electrons stored in the image sensor 20 is calculated by the controller 8B, based on the highest pixel value (corresponding to the highest brightness value) of the image data read out in the step ST11 and photographic conditions. More specifically, a value corresponding to the maximum amount of charges which can be generated in the image sensor 20 during capture of a still image is calculated based on the highest pixel value of the image data which is obtained in the monitoring mode, conditions set for the monitoring mode, and conditions in capturing a still image. Processes for the calculation will be described as follows.

For example, it is assumed that the highest pixel value of the image data which is obtained in the monitoring mode under conditions that the gain is set to the +6 dB in the analog signal processor 21, the shutter speed (SS) is set to 1/30 second, and the F number Fno is set to 8 in the monitoring mode, is 800. Then, consider a case where the gain is set to +12 dB in the analog signal processor 21, the shutter speed (SS) is set to 1/60 second, and the F number Fno is set to 8, in capturing a still image.

Since the highest pixel value of the image data in the monitoring mode is 800, a voltage of approximately 800 mV is applied to the A/D converter 22. Also, the image sensor 20 outputs a voltage of a half of 800 mV, i.e., 400 mV, because the gain in the monitoring mode is set to +6 dB (so that a ratio of output to input is two).

On the other hand, in capturing a still image, the image sensor outputs a voltage of 200 mV, because the shutter speed (SS) is half the shutter speed in the monitoring mode and the F number Fno is equal to that in the monitoring mode.

Then, using the fact that an output voltage of the image sensor 20 and the number of stored electrons are proportional to each other, the number of stored electrons in the case where the image sensor 20 outputs a voltage of 200 mV can be calculated as 8000, for example. When the number of stored electrons is 8000, it is appreciated from the graph of FIG. 6 that three charge storage gates will suffice. Accordingly, a voltage of 15 V, for example, is applied to the image sensor 20 in a step ST16 which will be later described in detail, so that the saturation electron number is set to 10000 which is a little bit larger than 8000.

In a step ST13, it is determined whether or not the number of stored electrons calculated in the step ST12 is equal to or larger than a predetermined number (15000, for example). If it is determined that the number of stored electrons is equal to or larger than the predetermined number, a step ST14 is performed. Otherwise, if it is determined that the number of stored electrons is smaller than the predetermined number, a step ST15 is performed.

In the step ST14, the drive pulses fed to the image sensor 20 from the timing generator 24 are set to have the A pattern shown in FIG. 9A. That is, when the highest brightness value of the image data is equal to or higher than a predetermined value, the drive pulses set to have the A pattern are fed to the image sensor 20. As a result, the number of charge storage gates in the image sensor 20 is set to four, and the transferable electron number is set to the relatively large number, 25000.

In the step ST15, the drive pulses fed to the image sensor 20 from the timing generator 24 are set to have the B pattern shown in FIG. 9B. That is, when the highest brightness value of the image data is lower than the predetermined value, the drive pulses set to have the B pattern are fed to the image sensor 20. As a result, the number of charge storage gates in the image sensor 20 is set to three, and the transferable electron number is set to the relatively small number, 15000.

As a result of the above-described operations in the steps ST13, ST14, and ST15, the drive pulses are set to have the A pattern in photographing a subject with a high brightness such as a sun, while the drive pulses are set to have the B pattern in photographing a subject with a uniform brightness such as paper documents. Hence, a dark noise can be appropriately suppressed.

Then, in a step ST16, the saturation level of the image sensor 20 is set. The saturation level (corresponding to the saturation electron number) of the image sensor 20 is set to the number not exceeding the transferable electron number contained in conditions for transfer which are set in the step ST14 or the step ST15. More specifically, when the drive pulses are set to have the A pattern in the step ST14, a voltage of 6 V is applied to the image sensor 20 by the D/A converter 23, and the saturation electron number is set to 20000. On the other hand, when the drive pulses are set to have the B pattern in the step ST15, a voltage of 15 V is applied to the image sensor 20, and the saturation electron number is set to 10000.

As a consequence of the above-described operations of the image capturing apparatus 1B, the number of charge storage gates, i.e., the transferable electron number, is changed in accordance with the highest brightness value of image data obtained in the monitoring mode, photographic conditions set for obtaining the image data, and photographic conditions set for capturing a still image. Accordingly, a dark noise can be suppressed, to thereby prevent degradation in quality of a captured image even in photographing a subject with a low brightness.

It is additionally noted that the waveform pattern of the drive pulses is not necessarily required to be determined based on the highest pixel value of image data in the image capturing apparatus 1B. Alternatively, the waveform pattern of the drive pulses may be determined based on the highest value out of respective average brightness values of sections obtained by dividing the image data. Further alternatively, the waveform pattern of the drive pulses may be determined based on information about a brightness received from an automatic exposure sensor provided in the image capturing apparatus 1B and photographic conditions.

Modification

In the above-described first and second preferred embodiments, information about a brightness of a subject for setting a gain in the analog signal processor, or the like, may alternatively be obtained by the image sensor driving circuit CU (FIG. 3), so that the number of charge storage gates, i.e., the transferable electron number, can be changed by the image sensor driving circuit CU, based on the obtained brightness information.

While the invention has been shown and described in detail, the foregoing description is in all aspects illustrative and not restrictive. It is therefore understood that numerous modifications and variations can be devised without departing from the scope of the invention.

What is claimed is:

1. An image capturing apparatus comprising:
an image sensor for generating an image signal;
a detector for detecting a brightness of a subject; and
a driver for selectively outputting one of a first drive signal and a second drive signal to said image sensor, in accordance with said brightness of said subject detected by said detector, wherein
said image sensor is set to have a first charge transfer capacity when said first drive signal is input to said image sensor from said driver, and
said image sensor is set to have a second charge transfer capacity which is smaller than said first charge transfer capacity when said second drive signal is input to said image sensor from said driver.

2. The image capturing apparatus according to claim 1, wherein
the number of charge storage gates in said image sensor is changed depending on a drive signal supplied from said driver, by which said first transfer capacity and said second charge transfer capacity are switched.

3. The image capturing apparatus according to claim 2, wherein
said image sensor includes an overflow drain for releasing charges stored in a photoelectric converter for performing photoelectric conversion, and
a saturation level of said photoelectric converter is changed depending on a potential of said overflow drain.

4. The image capturing apparatus according to claim 1, further comprising
an amplifier for amplifying said image signal generated by said image sensor, wherein
said detector detects said brightness of said subject based on a gain value of said amplifier, and
said driver outputs said first drive signal when said gain value is higher than a predetermined value while said driver outputs said second drive signal when said gain value is lower than said predetermined value.

5. The image capturing apparatus according to claim 1, wherein
said detector detects said brightness of said subject based on a highest brightness value of said image signal generated by said image sensor, and
said driver outputs said first drive signal when said highest brightness value is higher than a predetermined value while said driver outputs said second drive signal when said highest brightness value is lower than said predetermined value.

6. The image capturing apparatus according to claim 5, further comprising
a display for displaying an image, wherein
said detector detects said brightness of said subject based on said highest brightness value of said image signal which is generated by said image sensor to be displayed on said display.

7. The image capturing apparatus according to claim 1, wherein
a charge transfer capacity corresponds to a transferable electron number.

8. An image sensor driving circuit comprising:
an image sensor for generating an image signal;
a driver for selectively outputting one of a first drive signal and a second drive signal in accordance with brightness information of a subject, wherein
said image sensor is set to have a first charge transfer capacity when said first drive signal is input to said image sensor from said driver, and
said image sensor is set to have a second charge transfer capacity which is smaller than said first charge transfer capacity when said second drive signal is input to said image sensor from said driver.

9. The image sensor driving circuit according to claim 8, wherein
the number of charge storage gates in said image sensor is changed depending on a drive signal supplied from said driver, by which said first transfer capacity and said second charge transfer capacity are switched.

10. The image sensor driving circuit according to claim 9, wherein
said image sensor includes an overflow drain for releasing charges stored in a photoelectric converter for performing photoelectric conversion, and
a saturation level of said photoelectric converter is changed depending on a potential of said overflow drain.

11. The image sensor driving circuit according to claim 8, wherein
a charge transfer capacity represents a transferable electron number.

12. An image capturing method comprising the steps of:
(a) generating an image signal using an image sensor;
(b) detecting a brightness of a subject; and
(c) selectively outputting one of a first drive signal and a second drive signal in accordance with said brightness of said subject detected in said step (b), wherein
said image sensor is set to have a first charge transfer capacity when said first drive signal is input, and
said image sensor is set to have a second charge transfer capacity which is smaller than said first charge transfer capacity when said second drive signal is input.
